(19) United States
(12) Patent Application Publication
(10) Pub. No.: US 2008/0041988 A1
(43) Pub. Date: Feb. 21, 2008

(54) Paper shredder having paper brush-off device

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,676

(22) Filed: May 7, 2007

(30) Foreign Application Priority Data
May 22, 2006 (TW) 095208780

(51) Int. Cl. B02C 23/00

(52) U.S. Cl. 241/100

(57) ABSTRACT

A paper shredder including at lest one brush-off device provided at a paper drop opening of a casing. The brush-off device includes bristles extending towards the shafts. The entire brush-off device is able to slide reciprocally along an axial direction of the shaft so as to allow the user to actuate the brush-off device so as to remove shreds caught between two shafts at appropriate timing, thereby resolving the problem found in the conventional paper shredder where the paper shreds caught between two shafts may affect smooth shredding operation.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

This invention relates to a paper shredder, particularly to one having a brush-off device provided at a paper drop opening of a casing, such that the user is able to actuate a brush-off device so as to remove shreds caught between two shafts at appropriate timing, thereby resolving the problem found in the conventional paper shredder where the paper shreds caught between two shafts may affect smooth shredding operation.

2. Background

It is widely known that paper shredders for shredding incorporate plural cutting blades and spacers passing through rotary shafts that are driven to rotate towards each other by a motor and gear box so as to shred paper passing through the rotary shafts into strips by shear forces. Shredders can be classed into two types, the stripe-cut shredders and crosscut shredders, according to the machine cutting style. The former shredders arrange cutting blades to the rotating cutter shafts in a manner for cutting the paper in a longitudinal direction to form strips. The later shredders include blades that include more than one cutting edge part, and each cutter is disposed helically along the rotary cutter shaft for first cutting paper along a horizontal direction into strips and then cutting paper along a longitudinal direction into shreds of 4 mm by 40 mm.

Regardless of being stripe-cut or crosscut shredders, a wastebasket or bin commonly accompanies the shredders at sales. That is, the commercially available paper shredders are usually constructed of a cutter assembly, a casing and a wastebasket. As said, the cutter assembly of a conventional paper shredder includes two rotary shafts that are driven to rotate towards each other by a motor and gear box so as to shred paper passing through the rotary shafts into strips by shear forces. Therefore, the conventional paper shredders are provided exactly at the top and lower end thereof with a paper feeding opening and a paper drop opening that are parallel to the shafts, and the paper feeding opening and paper drop opening are substantially located between two shafts such that the paper fed through the paper feeding opening can be directly extended between two shafts, and that the shreds shredded by the shafts may fall into the wastebasket via the paper drop opening.

In reality, even though the shreds shredded by the shafts would fall into the wastebasket due to gravity, part of the shreds may be caught between two shafts. The shreds that have been accumulated for a period of time may affect the contact between the cutters and paper thereby reducing the smooth shredding operation. Under serious conditions, such shreds may even prevent the paper from being shredded at desire. Thus, one needs to periodically remove the shreds caught between two shafts. In the past, the user will need to cut off power of the paper shredder prior to inserting one's fingers' to remove the shreds caught between two shafts. However, the cutters may still slash one's fingers during such operation.

### SUMMARY OF INVENTION

It is thus a primary object of this invention to provide a paper shredder allowing the user to actuate a brush-off device so as to remove shreds caught between two shafts at appropriate timing, thereby resolving the problem found in the conventional paper shredder where the paper shreds caught between two shafts may affect smooth shredding operation.

To achieve the above object, the paper shredder of this invention includes at lest one brush-off device provided at a paper drop opening of a casing. The brush-off device includes bristles extending towards the shafts. The entire brush-off device is able to slide reciprocally along an axial direction of the shaft so as to allow the user to actuate the brush-off device so as to remove shreds caught between two shafts at appropriate timing, thereby resolving the problem found in the conventional paper shredder where the paper shreds caught between two shafts may affect smooth shredding operation.

### BRIEF DESCRIPTION OF THE DRAWINGS

These and other modifications and advantages will become even more apparent from the following detained description of a preferred embodiment of the invention and from the drawings in which:

FIG. 1 is a perspective view showing the basing of the shredder of this invention;

FIG. 2 is a structural cross-sectional view illustrating the arrangement of the brush-off device in this invention; and

FIG. 3 is a schematic view illustrating the operation of the brush-off device of this invention.

### DETAILED DESCRIPTION OF THE INVENTION (PREFERRED EMBODIMENTS)

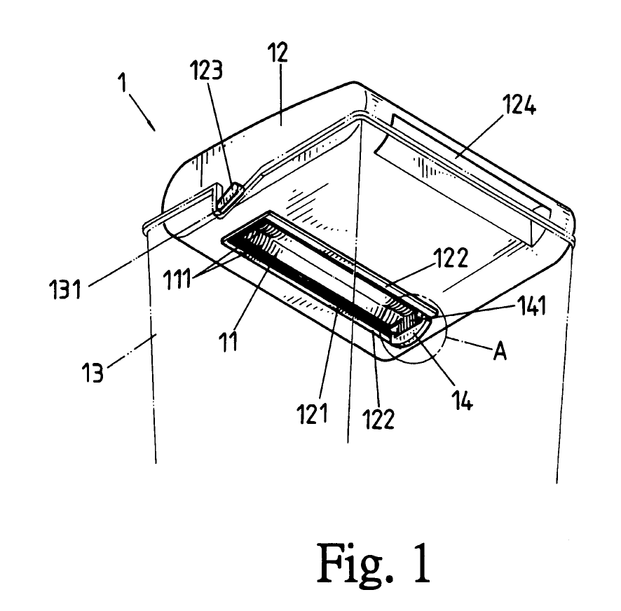

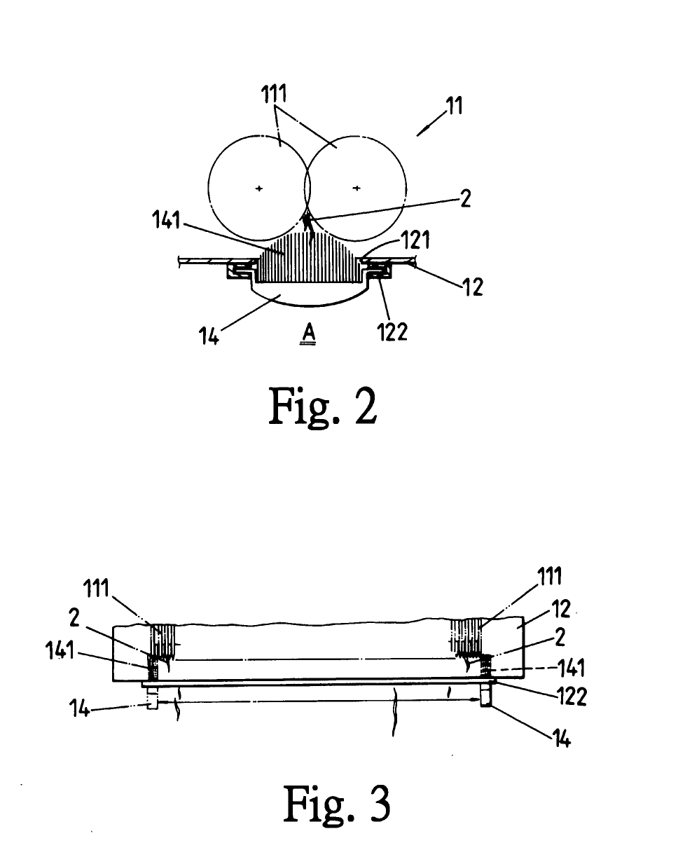

With reference to the drawings, FIG. 1 is a perspective view showing the basing of the shredder of this invention; FIG. 2 is a structural cross-sectional view illustrating the arrangement of the brush-off device in this invention; and FIG. 3 is a schematic view illustrating the operation of the brush-off device of this invention.

As shown, a paper shredder basically includes a cutter assembly 11, a casing 12 encasing the cutter assembly, and a wastebasket 13 for collecting paper shreds. The cutter assembly 11 includes two rotary shafts 111 that are parallel to and driven to rotate towards each other by a motor and gear box so as to shred paper passing through the rotary shafts into strips by shear forces, or to further shred the strips into fragmented chips. The casing 12 encases the cutter assembly therein and includes a paper feeding opening and a paper drop opening 121 exactly at a top and bottom end thereof and parallel to the shafts 111, for guiding paper through the two shafts 11 of the cutter assembly, and guiding the paper shreds into the wastebasket 13 through the paper drop opening 121.

The features of this invention reside in that, the casing 1 of the paper shredder 1 is provided at the paper drop opening 121 thereof with at least one brush-off device 14. The brush-off device 14 includes bristles 141 extending towards the shafts 111. In practice, the paper drop opening 121 of the casing 12 includes a sliding rail 122 neighboring its periphery, and the entire brush-off device 122 is mounted in the sliding rail 122, such that the brush-off device 122 is capable of sliding reciprocally along the shafts 111 of the cutter assembly in an axial direction. As such, the user is able to actuate the brush-off device 14 so as to remove shreds 2 caught between the shafts 111. The brush-off device includes bristles extending towards the shafts. The entire brush-off device is able to slide reciprocally along the shafts along the axial direction, so as to allow the user to actuate a brush-off device so as to remove shreds caught between two shafts at appropriate timing, thereby resolving the problem found in the conventional paper shredder where the paper shreds caught between two shafts may affect smooth shredding operation.

Since the user is able to remove shreds by actuating the brush-off device, this invention enhances convenience in performing the shreds removing operation, prevents the user's fingers from being slashed by the cutters mounted on the shafts, and significantly improves safeness in removing the shreds. Furthermore, as shown in FIG. 1, the entire paper shredder 1 may further includes two corresponding notches 131 at an upper edge of the wastebasket 13 while the casing 12 is provided at opposing sides with two corresponding ears 123 mounting over the two notches 131. In this paper shredder 1, the casing 12 and cutter assembly 11 may then be mounted over the wastebasket 13 by having a front edge of the casing 12 and the ears 123 at opposing sides to engage with a top edge of the wastebasket 13. Furthermore, the casing 12 may further be formed with in indent 124 at its front edge to allow easy access by one's fingers, such that the user can directly flip the casing 12 upwards for exposing the brush-off device located beneath the casing, for enhancing convenience in use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A paper shredder having paper brush-off device, including a cutter assembly, a casing encasing the cutter assembly, and a wastebasket for collecting paper shreds, characterized in that, the casing is provided at a paper drop opening thereof with at least one brush-off device capable of sliding reciprocally along shafts of the cutter assembly in an axial direction, the brush-off device including bristles extending towards the shafts thereby allowing the user to actuate the brush-off device so as to remove shreds caught between the shafts.

2. The paper shredder having paper brush-off device of claim 1, wherein the paper drop opening of the casing includes a sliding rail neighboring its periphery, and the brush-off device is mounted in the sliding rail.
